(19) United States
(12) Patent Application Publication
(10) Pub. No.: US 2007/0133085 A1
(43) Pub. Date: Jun. 14, 2007

(54) Microscope control device

(75) Inventor: Steven A. Scampini, Boston, MA (US)

Correspondence Address: VISTA IP LAW GROUP LLP, 12930 Saratoga Avenue, Suite D-2, Saratoga, CA, 95070, US

(73) Assignee: Cytyc Corporation, Marlborough, MA (US)

(21) Appl. No.: 11/298,953

(22) Filed: Dec. 9, 2005

(51) Int. Cl. G02B 21/00

(52) U.S. Cl. 359/383; 359/368

(57) ABSTRACT

A microscope control device comprises a coarse focus control, a manual navigation control, and a fine focus control. The microscope control device also includes a clutch configured to alternatively activate one of the coarse focus control and manual navigation control. The fine focus control, coarse focus control, manual navigation control, and clutch are configured and arranged for manual manipulation by a single hand of an operator without changing a general position of the hand.

### FIELD OF INVENTION

The present invention generally relates to devices for screening and reviewing cytological specimens fixed to specimen slides, and more particularly, to devices for controlling microscopes.

### DESCRIPTION OF RELATED ART

Many medical diagnostic tests, such as pap smears, require a physician to collect cells by brushing and/or scraping a skin or mucous membrane in a target area with an instrument. The collected cells are typically smeared (“fixed”) onto a slide, and stained to facilitate examination under a microscope by a cytotechnologist and/or pathologist. For example, a pathologist may employ a polychrome technique, characterized by staining the nuclear part of the cells, to determine the presence of dysplasia or neoplasia. The pathologist may also apply a counter-stain for viewing the cytoplasm of the cells.

Commercially available cytological imaging systems are used primarily to assist human evaluation of cytological specimen slides, e.g., containing cervical cell smears. One commercially available cytological imaging system is the Thin Prep Imaging System, manufactured and distributed by Cytyc Corporation (www.cytyc.com), which uses image processing technology to isolate cellular objects in a cytological specimen fixed to a slide (“specimen slide”), and identify a fixed number of regions (“fields of view”) on the slide containing objects of interest in the specimen for later review, e.g., by a cytotechnologist. Because the presented fields of view have been prescreened, the cytotechnologist is more likely to recognize specimens with “suspicious” (e.g., abnormal or possibly abnormal) cells.

The Thin Prep Imaging System includes two main components: an imager and a review scope. Within the imager, specimen slides are removed from respective cassettes in which they are stored, imaged, and returned to the cassettes in a serial fashion. The imager includes an image processor, which digitizes and processes the image data to identify objects of interest for further review, with the x, y slide coordinates of a number of fields of view of the specimen slide including these identified objects being selected for viewing by the cytotechnologist. A present commercial version of the Thin Prep Imaging System selects twenty fields of view containing one or more single objects of interest, and two fields of view containing one or more cluster objects of interest, for subsequent review on a review scope by a cytotechnologist.

The review scope is a traditional microscope interface with a motorized stage that presents the selected fields of interest for a specimen slide according to the route determined by the image processor. The cytotechnologist views each of the identified fields of interest and makes decisions about the level of possible cell abnormality, if any. To advance from one field of interest to the next, the cytotechnologist activates a switch. The cytotechnologist is able to return to a previously viewed field of interest, and manually move to (and view) locations on the slide that were not pre-selected for viewing.

The review scope also provides a means for the cytotechnologist to electronically mark objects for further review. If any electronic marks are made on a specimen slide by the cytotechnologist, the review scope requires completion of an “autoscan” following the review of that slide, which provides viewing coverage of the full specimen on the slide. The cytotechnologist is able to pause the autoscan and to move the stage in order to re-position and access locations on the slide, as desired. The cytotechnologist is also able to specify the autoscan parameters, including scanning direction, scanning motion profile (i.e., continuous or start/stop) and scan speed.

Currently, focus controls for the review scope are disposed on the body of the scope, and navigation controls are disposed on a pod and a keypad, both of which are connected to a controller. The placement of these controls for the review scope in three separate areas requires repeated coarse hand movements, which slows the review process and leads to user fatigue and repetitive motion injury. Devices for controlling review scopes in a manner that decrease these coarse hand movements would be highly desirable.

### SUMMARY OF THE INVENTION

In some embodiments, a microscope control device comprises a coarse focus control and a manual navigation control, wherein the coarse focus control and manual navigation control are configured and arranged for manual manipulation by a single hand of an operator without changing a general position of the hand. The microscope control device also includes a fine focus control, and the fine focus control, the coarse focus control, and the manual navigation control are configured and arranged for manual manipulation by the single hand of the operator without changing the general position of the hand. The microscope control device also includes a clutch configured to alternatively activate one of the coarse focus control and manual navigation control, wherein the coarse focus control, manual navigation control, and clutch are configured and arranged for manual manipulation by a single hand of an operator without changing a general position of the hand.

In some embodiments, a microscope control device, comprises a plurality of focus controls and a plurality of supplementary controls, wherein the focus controls and supplementary controls are configured and arranged for manual manipulation by a single hand of an operator without changing a general position of the hand. The focus controls comprise a coarse focus control and a fine focus control. The supplementary controls comprise a plurality of navigation controls, an objective control, and a marker control. The navigation controls comprise a plurality of semi-automatic navigation controls and a manual navigation control, wherein the semi-automatic navigation controls are configured to allow an operator to select a field of view from a plurality of pre-determined fields of view.

The supplementary controls also include a plurality of light source controls configured to allow the operator to modify one or more of an intensity, a color, and a color temperature of a light source. The supplementary controls also include a plurality of data entry controls configured to allow the operator to modify a database. The microscope control device also includes a clutch configured to alternatively activate the plurality of focus controls and plurality of supplementary controls, wherein the focus controls, supplementary controls, and clutch are configured and arranged for manual manipulation by a single hand of an operator without changing a general position of the hand.

In some embodiments, a microscope comprises a base, an imaging stage disposed on the base, an objective lens disposed above the imaging stage, a plurality of stage motors configured to reposition the imaging stage relative to the objective lens, an ocular lens disposed above the objective lens, a coarse focus control configured to reposition the ocular lens relative to the objective lens, a manual navigation control configured to allow an operator to direct the stage motors, and a controller connected to the stage motors and the manual navigation control, wherein the coarse focus control and manual navigation control are configured and arranged for manual manipulation by a single hand of an operator without changing a general position of the hand.

The microscope also comprises a second objective lens, an objective lens motor configured to move the objective lens and the second objective lens, and an objective control configured to allow an operator to direct the objective lens motor, wherein the coarse focus control, the manual navigation control, and objective control are configured and arranged for manual manipulation by the single hand of the operator without changing the general position of the hand.

The microscope also comprises a marker, a marker motor configured to move the marker, and a marker control configured to allow an operator to direct the marker motor, wherein the coarse focus control, manual navigation control, and marker control are configured and arranged for manual manipulation by the single hand of the operator without changing the general position of the hand. The microscope also includes a clutch configured to alternatively activate the coarse focus control and manual navigation control, wherein the coarse focus control, manual navigation control, and clutch are configured and arranged for manual manipulation by a single hand of an operator without changing a general position of the hand.

In some embodiments, the semi-automatic navigation controls comprise a first activator and a second activator. In some embodiments, the manual navigation control is configured to allow an operator to move the field of view and is selected from the group consisting of a joystick and a trackball.

### BRIEF DESCRIPTION OF THE DRAWINGS

In order to better understand and appreciate the invention, reference should be made to the drawings and accompany detailed description, which illustrate and describe exemplary embodiments thereof. For ease in illustration and understanding, similar elements in the different illustrated embodiments are referred to by common reference numerals. In particular:

FIG. 1 is a schematic view of a microscope with a microscope control device according to one embodiment of the invention.

### DETAILED DESCRIPTION OF ILLUSTRATED EMBODIMENTS

In the following description of the illustrated embodiments, it will be understood by those skilled in the art that the drawings and specific components thereof are not necessarily to scale, and that various structural changes may be made without departing from the scope or nature of the various embodiments.

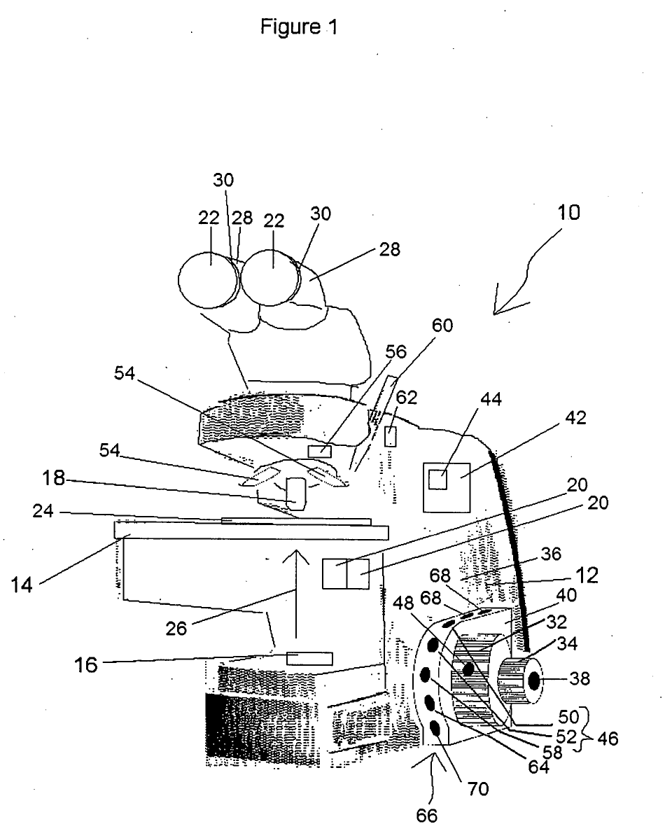

Referring to FIG. 1, a microscope 10 is shown. The microscope 10 has a base 12, a stage 14 mounted onto the base 12, a light source 16 mounted below the stage 14, an objective lens 18 mounted above the stage 14, stage motors 20 configured to reposition the stage 14 relative to the objective lens 18, and a pair of ocular lenses 22 mounted above the objective lens 18. The stage 14 is configured to securely hold a slide 24. Light from the light source 16, travel along a light path 26 through the stage 14, the slide 24, the objective lens 18 and the ocular lenses 22. Mirrors (not shown) may be placed along the light path 26 to allow the light path 26 to deviate from a linear geometry.

The microscope 10 is compound because the objective lens 18 and the ocular lenses 22 cooperate to magnify the specimen (not shown) in the slide 24. The pair of ocular lenses 22 are configured to provide a stereoscopic image having a sense of depth. The lengths of the mounts 28 holding the ocular lenses 22 are adjustable by twisting the eyepieces 30 to accommodate the visual acuity of an individual user.

The microscope 10 also includes a coarse focus control 32 and a fine focus control 34, mounted on the right side 36 of the base 12, for a right handed user. The coarse focus control 32 is a knob, which is rotatable to modify the distance between the ocular lenses 22 and the objective lens 18, thereby changing the focus of the microscope 10. The fine focus control 34 is also a rotatable knob that works the same way as the coarse focus control 32, only on a smaller scale. Consequently, a 360 degree rotation of the fine focus knob changes the distance between the ocular lenses 22 and the objective lens 18 by a much smaller amount than a 360 degree rotation of the coarse focus knob.

The microscope 10 also includes a manual navigation control 38 mounted on the an ledge 40, which extends from the base 12. The manual navigation control 38 is connected to a controller 42 and configured to send signals to the controller 42 when the manual navigation control 38 is activated. When the controller 42 receives the signals from the manual navigation control 38, the controller 42 in turn sends signals to direct the stage motors 20 to move the stage 14 and the slide 24 secured thereon. The manual navigation control 38 can be either a joystick or a trackball. The coarse focus control 32, the fine focus control 34 and the manual navigation control 38 are mounted to the base 12 so that they can be manually manipulated by a single hand of an operator (not shown) without changing the general position of the hand.

An automatic review system (not shown) has previously identified areas of interest on the slide 24 based on the presence of objects of interest, e.g. dark color cells, in a field of view. The automatic review system has also organized the areas of interest into a sequence in order to minimize a total distance that must be covered to move between all of the areas of interest. The sequence of areas of interest is stored in a memory 44 in the controller 42.

The microscope 10 also includes a plurality of semi-automatic navigation controls, which are also mounted on the ledge 40 so that they can be manually manipulated, along with the coarse focus control 32, the fine focus control 34 and the manual navigation control 38, by a single hand of an operator (not shown) without changing the general position of the hand. The semi-automatic navigation controls 46 include a pair of activators comprising a next button 50 and a previous button 52, which are connected to the controller 42 and configured to send signals to the controller 42 when the buttons 50/52 are depressed. When the controller 42 receives the signal from the next button 50, the controller 42 in turn sends signals to direct the stage motors 20 to move the stage 14 and the slide 24 secured thereto through the sequence of areas of interest stored in the controller 42 in one direction. When the controller 42 receives the signal from the previous button 52, the controller 42 in turn sends signals to direct the stage motors 20 to move the stage 14 and the slide 24 through the sequence of areas of interest stored in the controller 42 in the opposite direction. The semi-automatic navigation controls 46 can also comprise a dial (not shown).

The microscope 10 has a plurality of objective lenses 54 mounted to the base 12, which have different magnifications from that of the objective lens 18. The microscope 10 also has an objective motor 56, which is connected to the controller 42 and configured to move the objective lenses 54/18 into the light path 26. The microscope 10 includes an objective control 58 connected to the controller 42 and configured to send a signal to the controller 42 when the objective control 58 is activated. When the controller 42 receives a signal from the previous button 52, the controller 42 in turn sends signals to direct the objective motor 56 to move the objective lenses 54/18 in the light path 26. The objective control 58 is also mounted on the ledge 40 so that it can be manually manipulated, along with the coarse focus control 32, the fine focus control 34, the manual navigation control 38 and the semi-automatic navigation controls 46, by a single hand of an operator (not shown) without changing the general position of the hand.

The microscope 10 has a marker 60 mounted to the base 12 and configured to physically mark the slide 24. The microscope 10 also has a marker motor 62, which is connected to the controller 42 and configured to move marker 60 onto the slide 24. The microscope 10 includes a marker control 64 connected to the controller 42 and configured to send a signal to the controller 42 when the marker control 64 is activated. When the controller 42 receives a signal from the marker control 64, the controller 42 in turn sends signals to direct the marker motor 62 to move marker 60 onto the slide 24. The marker control 64 is also mounted on the ledge 40 so that it can be manually manipulated, along with the coarse focus control 32, the fine focus control 34, the manual navigation control 38, the semi-automatic navigation controls 46 and the objective control 58, by a single hand of an operator (not shown) without changing the general position of the hand.

Instead of physically marking the slide 24, the marker control 64 can send a signal to the controller 42 to direct it to store the location of the field of view in the memory 44 in the controller 42.

The manual navigation control 38, the semi-automatic navigation controls 46, the objective control 58, the marker control 64, and other non-focus related controls are generically known as supplemental controls 66. The semi-automatic navigation controls 46, the objective control 58 and the marker control 64 are switches that may be optical, touch sensing or capacitive sensing. The supplemental controls can also be placed on the center of rotation of the fine focus control 34 or along the circumference of either the coarse focus control 32 or the fine focus control 34. Some embodiments may have a clutch 48 to disengage the coarse focus control 32 and the fine focus control 34 to allow the supplemental controls to be activated without changing the focus.

In some embodiments, the supplemental controls 66 include a plurality of light source controls 68, which are connected to the controller 42. The light source controls 68 and controller 42 allow an operator to modify an intensity, a color, and a color temperature of the light source 16.

In some embodiments, the supplemental controls 66 include a plurality of data entry controls 70, which are connected to the controller 42. The data entry controls 70 and the controller 42 allow an operator, using a heads-up-display (not shown) in a field of view (not shown), to modify a database with information about the slide 24.

In some embodiments, the coarse focus control 32 and the fine focus control 34 may also function as a joystick manual navigation control 38. In this embodiment, the coarse focus control 32 and the fine focus control 34 are configured to change the focus without changing the position of the stage 14 and slide 24 when the clutch 48 is in a first position and configured to function as a manual navigation control 38 without changing the focus when the clutch 48 is in a second position.

In some embodiments, the coarse focus control 32 and the fine focus control 34 may be displaceable along the axis of rotation to disengage from the focus controlling mechanism and to engage control mechanisms analogous to the manual navigation control 38, the semi-automatic navigation controls 46, the objective control 58 and the marker control 64.

Although various embodiments of the invention have been shown and described herein, it should be understood that the above description and figures are for purposes of illustration only, and are not intended to be limiting of the invention, which is defined only by the appended claims and their equivalents.

What is claimed:

1. A microscope control device, comprising:
a coarse focus control; and
a manual navigation control, wherein the coarse focus control and manual navigation control are configured and arranged for manual manipulation by a single hand of an operator without changing a general position of the hand.

2. The microscope control device of claim 1, further comprising a fine focus control, wherein the fine focus control, the coarse focus control, and the manual navigation control are configured and arranged for manual manipulation by the single hand of the operator without changing the general position of the hand.

3. The microscope control device of claim 1, wherein the manual navigation control is configured to allow the operator to select a field of view, the manual navigation control selected from the group consisting of a joystick and a trackball.

4. The microscope control device of claim 1, further comprising a clutch configured to alternatively activate one of the coarse focus control and manual navigation control, wherein the coarse focus control, manual navigation control, and clutch are configured and arranged for manual manipulation by a single hand of an operator without changing a general position of the hand.

5. A microscope control device, comprising:
a plurality of focus controls; and
a plurality of supplementary controls, wherein the focus controls and supplementary controls are configured and arranged for manual manipulation by a single hand of an operator without changing a general position of the hand.

6. The microscope control device of claim 5, the focus controls comprising
a coarse focus control; and
a fine focus control.

7. The microscope control device of claim 5, the supplementary controls comprising
a plurality of navigation controls;
an objective control; and
a marker control.

8. The microscope control device of claim 7, the navigation controls comprising
a plurality of semi-automatic navigation controls; and
a manual navigation control, wherein the semi-automatic navigation controls are configured to allow an operator to select a field of view from a plurality of pre-determined fields of view.

9. The microscope control device of claim 8, the semi-automatic navigation controls comprising a first activator and a second activator.

10. The microscope control device of claim 8, wherein the manual navigation control is configured to allow an operator to move the field of view, the manual navigation control selected from the group consisting of a joystick and a trackball.

11. The microscope control device of claim 5, the supplementary controls comprising a plurality of light source controls configured to allow the operator to modify one or more of an intensity, a color, and a color temperature of a light source.

12. The microscope control device of claim 5, the supplementary controls comprising a plurality of data entry controls configured to allow the operator to modify a database.

13. The microscope control device of claim 5, further comprising a clutch configured to alternatively activate the plurality of focus controls and plurality of supplementary controls, wherein the focus controls, supplementary controls, and clutch are configured and arranged for manual manipulation by a single hand of an operator without changing a general position of the hand.

14. A microscope, comprising:
a base;
an imaging stage disposed on the base;
an objective lens disposed above the imaging stage;
a plurality of stage motors configured to reposition the imaging stage relative to the objective lens;
an ocular lens disposed above the objective lens;
a coarse focus control configured to reposition the ocular lens relative to the objective lens;
a manual navigation control configured to allow an operator to direct the stage motors; and
a controller connected to the stage motors and the manual navigation control, wherein the coarse focus control and manual navigation control are configured and arranged for manual manipulation by a single hand of an operator without changing a general position of the hand.

15. The microscope of claim 14, wherein the manual navigation control is selected from the group consisting of a joystick and a trackball.

16. The microscope of claim 14, further comprising a plurality semi-automatic navigation controls, wherein the coarse focus control, the manual navigation control, and semi-automatic navigation controls are configured and arranged for manual manipulation by the single hand of the operator without changing the general position of the hand.

17. The microscope of claim 16, the semi-automatic navigation controls comprising a first activator and a second activator, wherein the first and second activators are configured to allow an operator to select a field of view from a plurality of pre-determined fields of view.

18. The microscope of claim 14, further comprising a fine focus control, wherein the coarse focus control, the manual navigation control, and fine focus control are configured and arranged for manual manipulation by the single hand of the operator without changing the general position of the hand.

19. The microscope of claim 14, further comprising
a second objective lens;
an objective lens motor configured to move the objective lens and the second objective lens; and
an objective control configured to allow an operator to direct the objective lens motor, wherein the coarse focus control, the manual navigation control, and objective control are configured and arranged for manual manipulation by the single hand of the operator without changing the general position of the hand.

20. The microscope of claim 14, further comprising
a marker;
a marker motor configured to move the marker; and
a marker control configured to allow an operator to direct the marker motor, wherein the coarse focus control, manual navigation control, and marker control are configured and arranged for manual manipulation by the single hand of the operator without changing the general position of the hand.

21. The microscope of claim 14, further comprising a clutch configured to alternatively activate the coarse focus control and manual navigation control, wherein the coarse focus control, manual navigation control, and clutch are configured and arranged for manual manipulation by a single hand of an operator without changing a general position of the hand.
